(19) United States
(12) Patent Application Publication
(10) Pub. No.: US 2005/0062931 A1
(43) Pub. Date: Mar. 24, 2005

(54) Nose pads for eyeglasses and eyeglasses

(75) Inventor: Fumiko Takeuchi, Tomioka-shi (JP)

Correspondence Address: Law Office of Townsend & Banta;Suite 900, South Building, 601 Pennsylvania Ave., N.W., Washington, DC, 20004, US

(73) Assignee: Cosmo Industry Co., Ltd.

(21) Appl. No.: 10/932,230

(22) Filed: Sep. 2, 2004

(30) Foreign Application Priority Data
Sep. 19, 2003 (JP) 2003-327548

(51) Int. Cl. G02C 1/00; G02C 5/12

(52) U.S. Cl. 351/78

(57) ABSTRACT

Nose pads for eyeglasses and eyeglasses having a germanium therapeutic effect are provided. The pair of nose pads for eyeglasses of the present invention comprise a main pad body made of a synthetic resin such as silicone resin, and a pad plate, a portion of the pad plate being embedded in the main pad body. The pad plate serves to engage a pad arm which is fixed to an eyeglass rim of eyeglasses. In each of these nose pads, a germanium pellet made of germanium or an alloy consisting principally of germanium, is embedded, exposing a surface of the germanium pellet so as to contact the nose in the vicinity of the Seimei acupoints of the face when the eyeglasses are worn by a user.

### FIELD OF THE INVENTION

The present invention provides nose pads, which are also known as “tabs,” for eyeglasses.

### BACKGROUND OF THE INVENTION

Germanium (chemical symbol: Ge), which is a semiconductor element having an atomic number of 32, has long been said to have a therapeutic effect. Germanium has been shown to limit damage to muscle cells resulting from active oxygen which is harmful to the human body. Furthermore, free electrons from germanium penetrate deeply into the body from the skin, to neutralize cations in the affected area, alleviating stiffness and pain, and regulating disturbances in organic electrical currents.

Furthermore, germanium is held to have a localized heating effect, an ion transfer effect, and an acupoint stimulation effect. It is also said to have such advantages as maintaining these effects semi-permanently, acting instantaneously, and providing shielding against light and electromagnetic fields, the effects being enhanced by heat, and having absolutely no side effects. Germanium therapies have been advocated which focus on the excellent therapeutic effects of germanium, and healthcare devices employing germanium are already on the market.

For example, a product is on the market wherein, as shown in a front view in FIG. 6(a) and in a sectional view in FIG. 6(b), a high purity (99.9%) discoid germanium particle 15, having a diameter of approximately 4 to 10 mm, is mounted on an adhesive support, such as a circular adhesive plaster 16, which is several centimeters in diameter. Therapeutic methods and techniques wherein such products are applied to various acupoints on the body in order to relieve stiffness and pain are well known.

Furthermore, accessories such as necklaces and bracelets on which a plurality of the germanium particles 15 described above are mounted are already on the market as health promoting products allowing for automatic germanium therapy. In other words, the effect of alleviating muscle stiffness, pain and the like with germanium is achieved simply by wearing the accessories, as the germanium particles 15 in the necklaces and bracelets come into contact with the acupoints around the neck or around the arm.

Many documents have already been published in well-known literature relating to germanium therapy, which describe the use of healthcare devices employing germanium in the manner described above. For example, the articles entitled “The latest power therapy in the germanium miracle” (Ryoichi Obitsu, Ed., “Saishin Gerumaniumu Kyoui No Pawaa Ryoho, first edition, Kenyukan, Sep. 30, 2001), and “New germanium therapy that works as soon as it is applied” (Kenichi Ishigaki, Ed., “Hatte Sugu Kiku Shin Gerumaniumu Ryoho, Ladies Boutique Series, Vol. 1544, Boutique-sha, Oct. 10, 2002), disclose the benefits of germanium, the use of germanium in therapy, and the products described above wherein germanium particles are affixed to adhesive plasters and applied to various acupoints on the body.

The Eastern medical practice of acupoint therapy teaches that an extremely large number of acupoints (meridian points) are present on the human body from the top of the head to the tip of the foot. Among these, an important pair of facial acupoints is that known as the Seimei (wakefulness) points. These Seimei acupoints are located in the vicinity of the deepest recess in the bone between the bridge of the nose and the eyeball, as indicated by the black dots P in FIG. 7, and can be felt by touching the inner corner of the eyes with the fingers. Stimulating these Seimei acupoints is effective in various disorders affecting the eyes.

However, people generally feel apprehensive about using the products described above, in which germanium particles are affixed to an adhesive plaster, on facial acupoints where the skin is particularly sensitive. Furthermore, even if skin-toned adhesive plasters are used, they can readily be seen, and therefore people are generally unwilling to wear them.

### SUMMARY OF THE INVENTION

The present invention is a reflection of this situation, and has focused on the fact that the locations at which nose pads for eyeglasses make contact with the nose is precisely in the region of the Seimei acupoints, and the fact that nose pads for eyeglasses are general-purpose devices that can easily be replaced. Consequently, an object of the present invention is to provide nose pads for eyeglasses, and eyeglasses fitted with the same, whereby a germanium therapy effect can be provided simply by wearing the eyeglasses.

In order to solve the aforementioned problems, the present invention provides:
(1) pair of nose pads for eyeglasses comprising germanium pellets made of germanium or an alloy consisting principally of germanium, the germanium pellets being embedded in the nose pads so as to expose a surface thereof so as to contact the nose when the glasses are worn;
(2) a pair of nose pads for eyeglasses comprising a film made of germanium or an alloy consisting principally of germanium, the film coating at least a surface in an area that makes contact with the nose;
(3) a pair of nose pads for eyeglasses, the pads comprising a main pad body having a pad plate embedded therein, the pad plate being made of germanium or an alloy consisting principally of germanium which is embedded in the main pad body so that a surface of the pad plate on a side facing the nose is exposed, so as to contact the nose when the glasses are worn; and
(4) eyeglasses comprising the pair of nose pads for eyeglasses set forth above in any one of (1) to (3).

The nose pads for eyeglasses and eyeglasses of the present invention are constituted so that a germanium pellet, a germanium pad plate or a germanium film provided at the nose pad as described above contacts the Seimei acupoint in the vicinity of the bridge of the nose, whereby:
(1) a therapeutic effect can be provided whereby various disorders of the eye (eye fatigue, eye strain and eye pain) are alleviated by the action of germanium on the Seimei acupoints while wearing the eyeglasses;
(2) as the constituent element germanium is not held against the face by applying of adhesive plasters or the like, appearance is in no way adversely affected and no discomfort is caused; and
(3) because the nose pads can be used as replacements for the nose pads of existing eyeglasses, they are convenient and versatile.

### BRIEF DESCRIPTION OF THE DRAWINGS

Embodiments of the nose pads for eyeglasses and the eyeglasses according to the present invention are described with reference to the accompanying drawings, wherein:

FIG. 1 is a perspective view of a pair of nose pads (embodiment 1) according to the present invention;

FIG. 2 is a side view of a pair of nose pads (embodiment 1) according to the present invention;

FIG. 3 is a side view of a pair of nose pads (embodiment 2) according to the present invention;

FIG. 4 is a side view of a pair of nose pads (embodiment 3) according to the present invention;

FIG. 5 is a partial enlarged perspective view of the nose pads of the present invention incorporated into eyeglasses;

FIG. 6(a) is a front view a conventional healthcare device using germanium;

FIG. 6(b) is a side view of a conventional healthcare device using germanium; and

FIG. 7 is a front view of a human face, illustrating the Seimei acupoints on the face, as taught in the Eastern medical practice of acupoint therapy.

### DETAILED DESCRIPTION OF THE INVENTION

### Embodiment 1

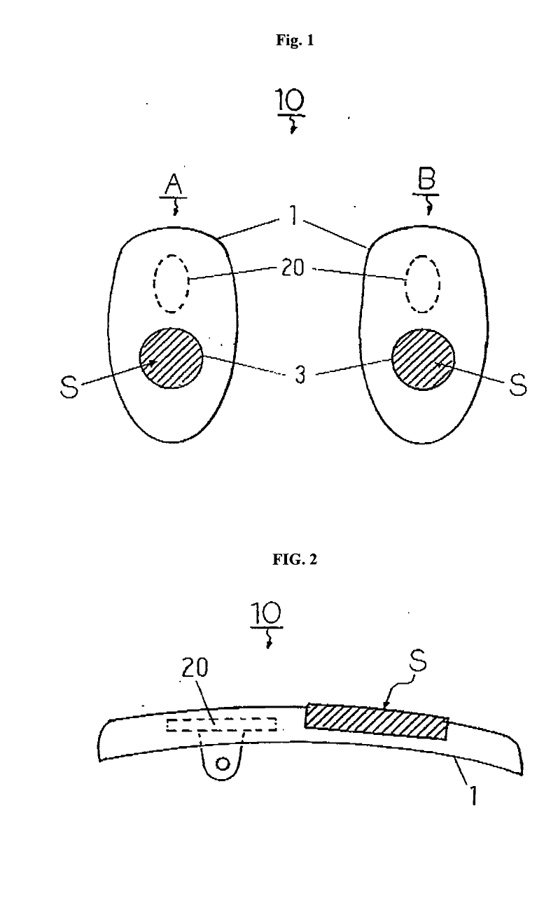

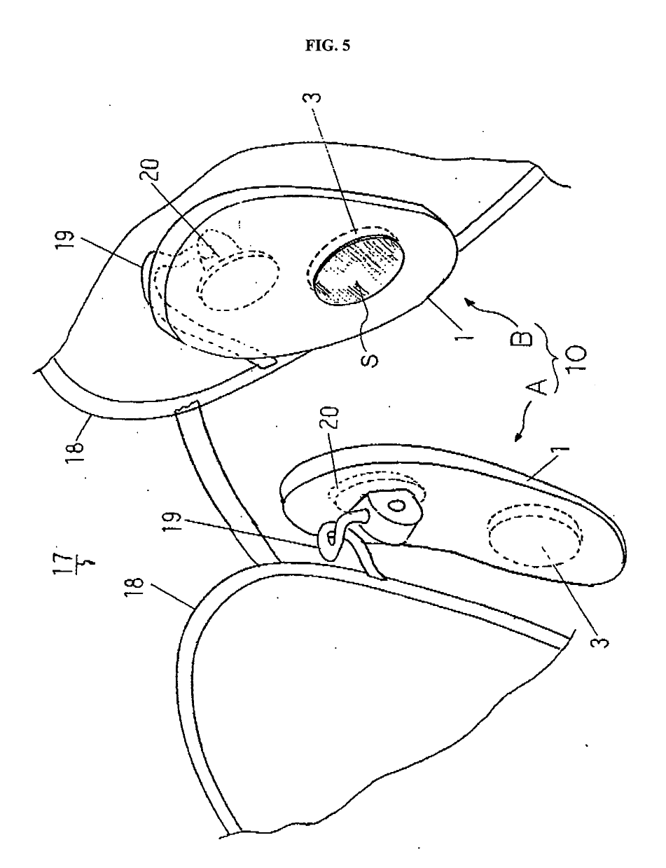

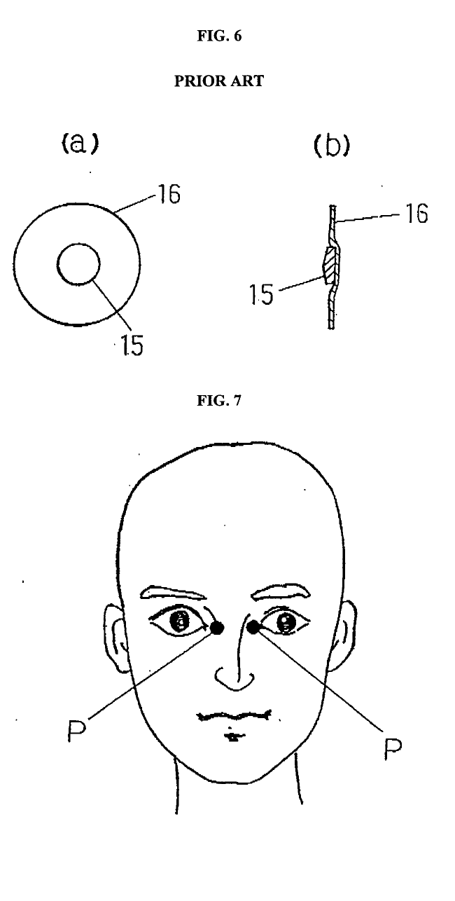

As shown in FIGS. 1 and 2, a pair of nose pads for eyeglasses 10 according to the present invention has a constitution wherein the nose pads for eyeglasses A and B comprise a main pad body 1 made of a synthetic resin such as silicone resin and a pad plate 20, a portion of which is embedded in the main pad body 1. The pad plate 20 serves to engage a pad arm 19, which is fixed to an eyeglass rim 18 of eyeglasses 17, as shown in FIG. 5. In these pads A and B, a germanium pellet 3 made of germanium or an alloy consisting principally of germanium, is embedded separately from the existing pad plate 20, so as to expose a surface S of the germanium pellet 3, and so as to contact the nose when the eyeglasses are worn.

It is essential that the germanium pellet be embedded in the main pad body 1 so that the surface S of the germanium pellet 3 is exposed so as to be flush with the surface of the main pad 1, or so as to protrude slightly (approximately 0.1 mm) therefrom, whereby the surface S reliably contacts the bridge of the nose in the vicinity of the Seimei acupoints when the glasses are worn. By virtue of the constitution described above, simply by wearing eyeglasses fitted with the pair of nose pads for eyeglasses 10, a germanium therapeutic effect is produced on the Seimei acupoints by the germanium pellet 3.

The material for the germanium pellet 3 is high purity (for example 99.9%) inorganic germanium or an alloy of gold or silver, having germanium as the principal component. The dimensions of the germanium pellet 3 can be suitably varied in consideration of the size of the nose pads A and B and the design of the eyeglasses and the like, but generally speaking are formed in the shape of a circle or a polygon having a diameter of 2 to 7 mm, or an ellipse having a major axis of 3 to 14 mm, these having thicknesses of about 0.3 to 1.2 mm.

### Embodiment 2

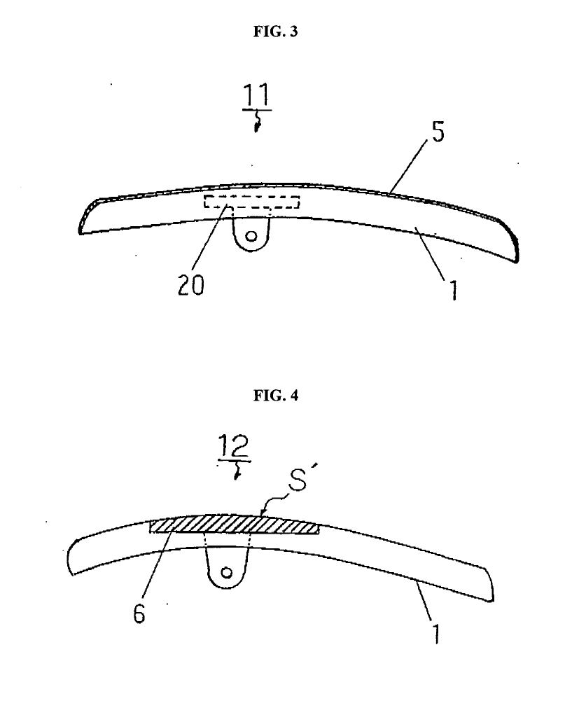

As shown in FIG. 3, a nose pad for eyeglasses 11 according to the present invention is characterized in that a pair of nose pads for eyeglasses comprises a main pad 1 made of a synthetic resin such as silicon resin and a pad plate 20, a portion of which is embedded in the main pad 1. The pad plate 20 serves to engage a pad arm 19, which is fixed to an eyeglass rim 18 of eyeglasses 17, as shown in FIG. 5. The nose pads are coated by a film 5 made of germanium or an alloy of gold or silver consisting principally of germanium (hereinafter, germanium film) on at least a surface of a part of the nose pad which contacts the nose.

The thickness at which the germanium film 5 is coated may be from a few dozen microns to a few hundred microns, in consideration of the therapeutic effect of the germanium. The germanium film 5 may coat the entire surface of the side of the nose pad facing the nose, as shown in FIG. 3, and this coating may include the backside of the nose pad, or the coating may be applied only to the region that contacts the nose, but from the point of view of efficient coating operations, it is preferable that the coating be applied to the entire surface of the side facing the nose. Germanium is a hard, grayish white lustrous metal, similar to silver, so that it is particularly harmonious with metal frames and produces a high-quality impression in terms of design.

### Embodiment 3

The germanium pellet 3 can also be provided by replacing all or a portion of the pad plate 20 in the nose pad with a germanium material. For example, as in the eyeglasses nose pad 12 shown in FIG. 4, the pad plate 6 embedded in the main pad body 1 is a germanium pad plate made of germanium or an alloy of gold or silver having germanium as the principal component thereof, and this germanium pad plate is embedded so that a surface S thereof is exposed on the side facing the nose, so as to contact the nose when the glasses are worn. It is, of course, essential that the surface S of the germanium pad plate 6 on the side facing the nose be flush with the surface of the main pad 1 or protrude slightly therefrom so as to reliably contact the nose in the vicinity of the Seimei acupoints.

Further, the eyeglasses according to the present invention are fitted with the eyeglasses nose pads 10 of the present invention as the nose pads therefor, in the manner of eyeglasses 17, shown in FIG. 5. Furthermore, the nose pads of existing eyeglasses may also be replaced with the nose pads 10 of the present invention.

One of the greatest advantages of the present invention is that the nose pads for eyeglasses 10, 11 and 12, themselves provide a germanium health promoting effect (a therapeutic effect including acting to relieve tiredness, strain and pain in the eyes). Consequently, without any incongruous sensation in terms of appearance, it is possible to alleviate tiredness and pain resulting from wearing eyeglasses and achieve a therapeutic effect by stimulating the Seimei acupoints.

Note that there are two types of germanium: inorganic germanium, which is a rare metal found in geological strata, and organic germanium, which is present in large quantities in medicinal plants such as Panax ginseng and Ganoderma lucidum. The germanium used in the present invention is inorganic germanium.

1. A pair of nose pads for eyeglasses comprising germanium pellets made of germanium or an alloy consisting principally of germanium, the germanium pellets being embedded in the nose pads so as to expose a surface thereof, and so as to contact the nose when the glasses are worn.

2. A pair of nose pads for eyeglasses comprising a film made of germanium or an alloy consisting principally of germanium, the film coating at least a surface of the nose pads in an area thereof that makes contact with a nose of a user.

3. A pair of nose pads for eyeglasses, the nose pads comprising a main pad body having a pad plate embedded therein, the pad plate being made of germanium or an alloy consisting principally of germanium which is embedded in the main pad body so that a surface of the pad plate on a side facing a nose of a user is exposed thereto, so as to contact the nose when the glasses are worn.

4. Eyeglasses comprising the pair of nose pads for eyeglasses recited in claim 1.

5. Eyeglasses comprising the pair of nose pads for eyeglasses recited in claim 2.

6. Eyeglasses comprising the pair of nose pads for eyeglasses recited in claim 3.
